(19) United States
(12) Patent Application Publication
(10) Pub. No.: US 2008/0121253 A1
(43) Pub. Date: May 29, 2008

(54) CLEANSING BIN

(76) Inventor: Craig R. Shotwell, Granite, MD (US)

Correspondence Address: LOWE HAUPTMAN HAM & BERNER, LLP, 1700 DIAGONAL ROAD, SUITE 300, ALEXANDRIA, VA, 22314, US

(21) Appl. No.: 11/564,262

(22) Filed: Nov. 28, 2006

(51) Int. Cl. B08B 3/04; B65D 21/032; B65D 8/04

(52) U.S. Cl. 134/25.4; 206/509; 220/669; 134/25.1; 134/42

(57) ABSTRACT

A bin for use in a dishwasher machine is described. The bin comprises a pair of opposing side panels, a rear panel connected to each of the pair of opposing side panels, a front panel connected to each of the pair of opposing side panels, and a bottom panel connected to (a) each of the pair of opposing side panels, (b) the rear panel, and (c) the front panel. Each side panel comprises at least one foot along a lower edge and each side panel defines at least one depression along an upper edge.

### BACKGROUND

Various baskets and containers have been used to retain jewelry and other items for cleaning using a dishwasher machine. The containers are constructed to fit within an available portion of a rack of the dishwasher machine and allow water and cleaning solution to penetrate the container and clean the contained items. Due to the size and capacity of the containers, the containers rely on a portion of the rack to provide support and/or positioning of the container within the dishwasher machine.

Further, the containers are arranged for use in the dishwasher machine and items to be cleaned need to be placed within the container separate from other containers within which the items may have been previously stored.

Further, as the containers are designed for use in a dishwasher machine, the containers may not be configured to be stored in a stackable manner.

### DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a perspective view of a cleansing bin according to an embodiment;

FIG. 2 is a perspective view of a cleansing bin according to a second embodiment;

FIG. 3 is a perspective view of a cleansing bin according to a third embodiment;

FIG. 4 is a perspective view of a cleansing bin according to a fourth embodiment; and

FIG. 5 is a front plan view of a cleansing bin according to an embodiment;

FIG. 6 is a left side plan view of a cleansing bin according to an embodiment;

FIG. 7 is an interior plan view of a right side panel according to the FIG. 2 embodiment;

FIG. 8 is an interior plan view of a right side panel according to the FIG. 3 embodiment;

FIG. 9 is a top plan view of a cleansing bin according to an embodiment;

FIG. 10 is a left side plan view of the bottom and front panels of a cleansing bin according to an embodiment;

FIG. 11 is a front plan view of a toothed divider for a cleansing bin according to an embodiment;

FIG. 12 is a front plan view of a divider for a cleansing bin according to an embodiment; and

FIG. 13 is a perspective view of a stacked pair of cleansing bins according to an embodiment.

### DETAILED DESCRIPTION

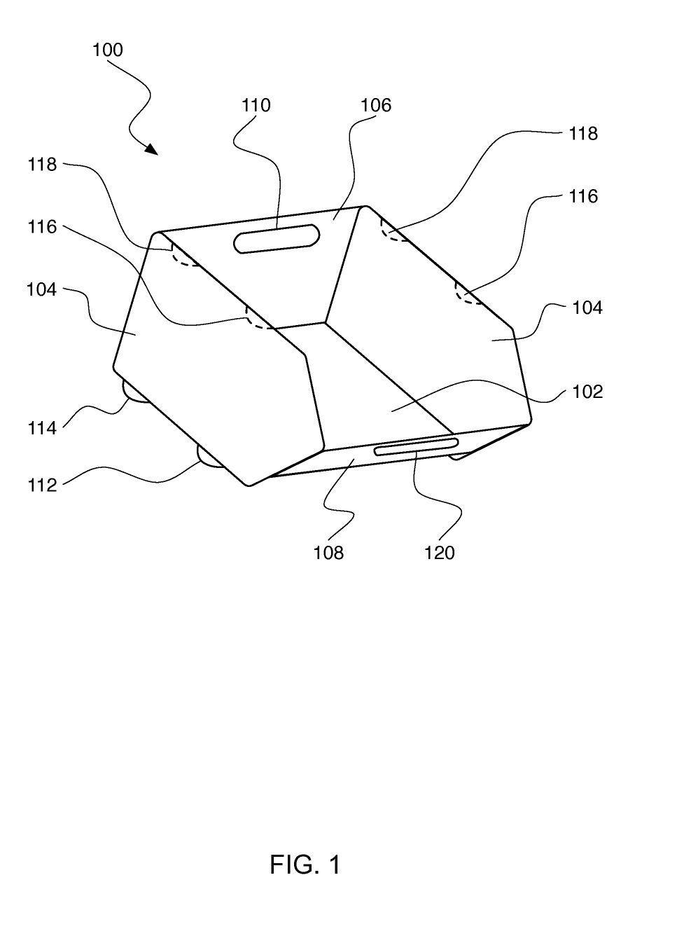

FIG. 1 depicts a perspective view of a cleansing bin 100 according to an embodiment. Cleansing bin 100 comprises a generally parallelogram-shaped bottom panel 102, a pair of identically-shaped side panels 104 each connected to opposite edges of the bottom panel, a rear panel 106 connected to an edge of the bottom panel and an edge of each of the side panels, and a front panel 108 connected to an edge of the bottom panel and an edge of each of the side panels. Bottom panel 102 is generally flat and horizontally-oriented and provides a surface for receiving objects placed within cleansing bin 100. The arrangement and connection of bottom panel 102, side panels 104, rear panel 106, and front panel 108 forms an upwardly opening bin for receiving objects, e.g., toys such as outside and inside children's play toys, bath toys, pool toys, etc., to be cleaned. In at least one embodiment, bottom panel 102 adjoins side panels 104 an offset distance from a lower edge of the side panels.

In at least one embodiment, each of side panels 104, rear panel 106, front panel 108, and bottom panel 102 comprise a non-corrosive, water-permeable configuration, e.g., a mesh, lattice, and/or honeycomb type material and/or another type of material allowing water to pass through the panels (102, 104, 106, 108) in order to clean objects placed in the bin 100. For example, the panels (102, 104, 106, 108) may comprise a plastic-coated wire mesh or honeycomb material and/or a rigid plastic mesh or honeycomb material.

In at least one embodiment, cleansing bin 100 is sized to replace a lower rack of a dishwasher machine. For example, a lower rack of a dishwasher machine may be removed from the dishwasher machine and replaced by cleansing bin 100. If cleansing bin 100 comprises toys, a wash cycle of the dishwasher machine may be executed in order to clean the toys in the cleansing bin.

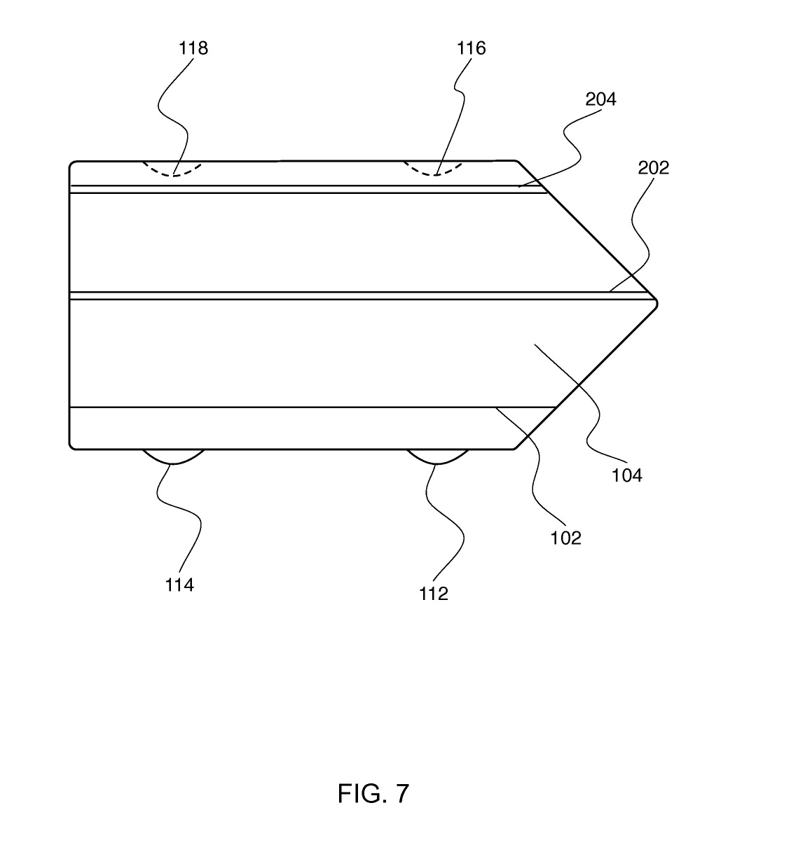

As depicted in FIG. 7, bottom panel 102 connects with side panels 104 at a distance 700 from the lower edge of the side panel. For example, in at least one embodiment, bottom panel 102 is positioned three inches (3″) above the lowest portion of convex feet 112, 114. According to the particular embodiment, positioning bottom panel 102 at a three inch height provides a three inch clearance to avoid lower sprayer mechanisms which may be present in a particular dishwasher machine. Greater or lesser amounts of clearance may be obtained by varying the position of bottom panel 102 with respect to side panels 104.

In at least one embodiment, bottom panel 102 comprises a raised center portion arranged to pass over an internal sprayer mechanism of a dishwasher machine when cleansing bin 100 is inserted in the dishwasher machine. For example, in such an embodiment, contact between cleansing bin 100 and an upwardly extending lower spray arm may be avoided. The raised center portion may comprise, for example, an inverted U-shaped protrusion of bottom panel 102.

In at least one embodiment, cleansing bin 100 is approximately twenty-one inches (21″) wide, approximately twenty-two inches (22″) deep and approximately eleven inches (11″) in height.

### Side Panels

As depicted, side panels 104 are pentagonal-shaped (five-sided) and rear panel 106 connects along a vertically extending edge of the side panels, bottom panel 102 connects adjacent a lower horizontally extending edge of the side panels, and front panel 108 connects along an angled upwardly sloping edge of the side panels.

As depicted in FIG. 1, the edge of side panel 104 to which front panel 108 connects extends upwardly at a one hundred thirty-five degree (135°) angle from the lower horizontal edge of the side panel. In some embodiments, the edge of side panel 104 to which front panel 108 connects extends upwardly at a greater or lesser angle.

In some embodiments, side panels 104 are not identically-shaped. In some embodiments, side panels 104 may have greater or lesser number of edges, e.g., quadrilateral-shaped, hexagonal-shaped, triangular-shaped.

Each of side panels 104 further comprises a pair of convex feet 112, 114 along a lower edge thereof. In at least one embodiment, convex (or rounded) feet 112,114 extend from, and form a portion of, the lower edge of side panels 104. In at least one other embodiment, convex feet 112,114 are attached to a lower edge of side panels 104. In at least one embodiment, convex feet 112, 114 may be cylindrical-shaped, parallelogram-shaped.

Further, each of side panels 104 comprises a pair of concave receptacles 116, 118 (dotted line) along an upper edge thereof. Each of receptacles 116, 118 is positioned to receive a corresponding convex foot 112, 114 of another cleansing bin positioned atop cleansing bin 100. That is, cleansing bin 100 is stackable on top of other cleansing bins of similar shape. In at least one embodiment, concave receptacles 116, 118 may form cylindrical-shaped holes, parallelogram-shaped holes corresponding to feet 112, 114.

In at least one embodiment, concave receptacles 116, 118 may be spaced apart to enable alternating the position of one cleansing bin with respect to another cleansing bin. For example, a first cleansing bin may be positioned one hundred eighty degrees (1800) orientation from a second cleansing bin such that the front panel of the first bin is located above the rear panel of the second bin.

In some embodiments, each of side panels 104 may be formed of a solid material.

### Rear Panel

Rear panel 106 is generally parallelogram-shaped and connects to both side panels 104. In at least one embodiment, opposite edges of rear panel 106 join a rearward vertically extending edge along side panels 104. Rear panel 106 also joins to a rearward edge of bottom panel 102. Further, rear panel 106 defines a handle opening 110 to enable easier lifting, carrying, and/or repositioning of cleansing bin 100.

In at least one embodiment, rear panel 106 lacks handle opening 110. In at least one embodiment, rear panel 106 extends vertically both above and below the joint with bottom panel 102.

### Front Panel

Front panel 108 is generally parallelogram-shaped and connects to both side panels 104. Front panel 108 also joins to a frontward edge of bottom panel 102. Similar to rear panel 106, front panel 108 defines a handle opening 120 to enable lifting, carrying, and/or repositioning cleansing bin 100.

In at least one embodiment, front panel 108 lacks handle opening 120. In at least one embodiment, front panel 108 extends both above and below the joint with bottom panel 102.

As described above, front panel 108 extends away from bottom panel 102 at a one hundred thirty-five degree (135°) angle. In at least some embodiments, front panel 108 extends at a greater or lesser angle from bottom panel 102. In at least some embodiments, front panel 108 is formed as an angled extension of bottom panel 102.

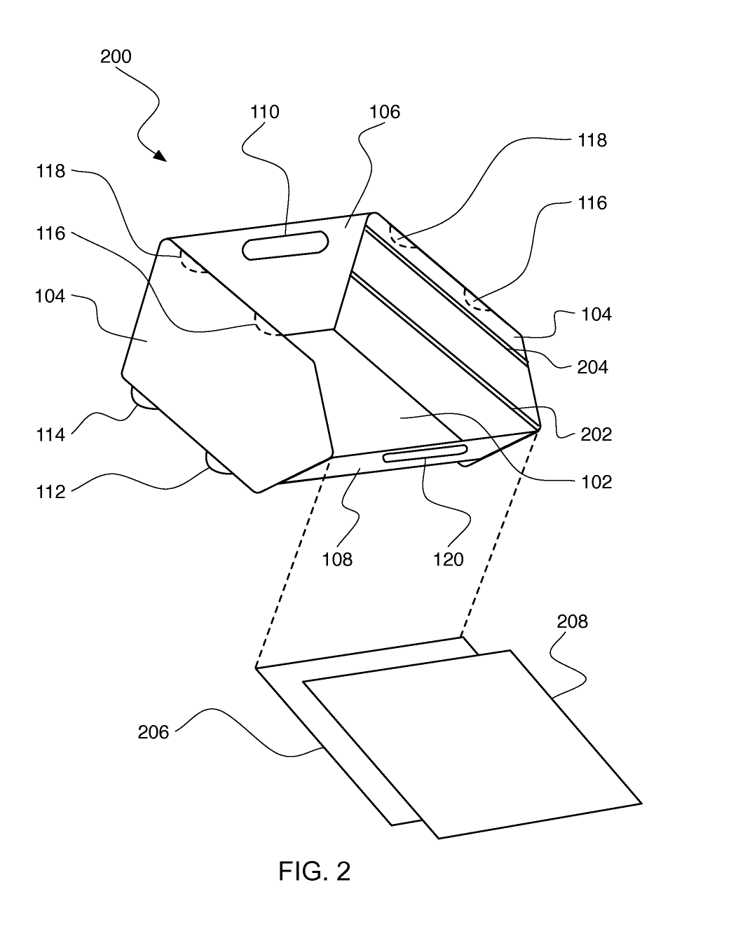

FIG. 2 depicts a perspective view of a cleansing bin 200 according to a second embodiment. Cleansing bin 200 differs from cleansing bin 100 in the addition of a first tray groove 202 extending horizontally and formed on each of side panels 104 and a second tray groove 204 extending horizontally and formed on each of the side panels. First and second tray grooves 202, 204 are formed on an inner face of side panels 104, i.e., interior to cleansing bin 200. A first tray 206 may be slid into first tray groove 202 to provide a greater usable surface area for placement of objects in cleansing bin 200 and/or to ensure retention of objects, e.g., smaller and/or lighter weight objects, within cleansing bin 200 during a wash cycle. A second tray 208 may be slid into second tray groove 204 to provide a greater usable surface area for placement of objects in cleansing bin 200. In at least one embodiment, first and second trays 206, 208 may comprise the same material as panels (102, 104, 106, 108).

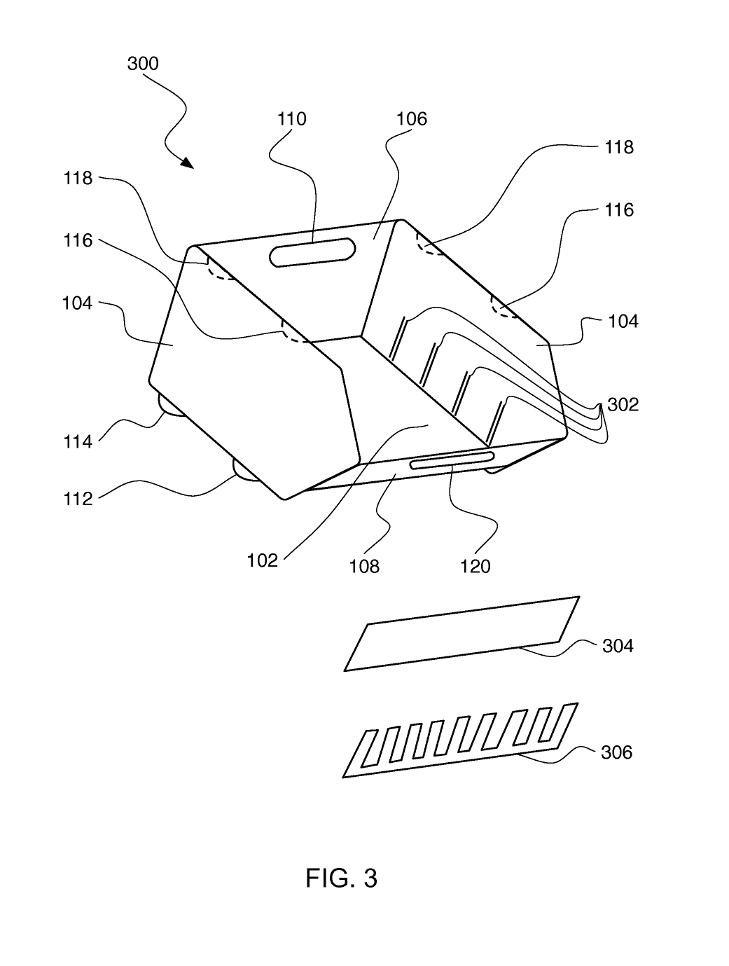

FIG. 3 depicts a perspective view of a cleansing bin 300 according to a third embodiment. Cleansing bin 300 differs from cleansing bin 100 in the addition of a set of divider grooves 302 extending vertically and formed on each of side panels 104. The set of divider grooves 302 are formed on an inner face of the side panels 104, i.e., interior to cleansing bin 300. In at least one embodiments, each of the set of divider grooves 302 may be the same and/or differing heights. A divider 304, e.g., a generally quadrilateral-shaped panel, may be slid into one of divider grooves 302 to subdivide the interior volume of cleansing bin 300 into smaller volumes. In at least one embodiment, more than one divider 304 may be used to subdivide the interior volume of cleansing bin 300 into successively smaller volumes.

In at least one embodiment, a single divider 304 may be used to subdivide the interior volume of cleansing bin 300 in half. In at least one other embodiment, two dividers 304 may be used to subdivide the interior volume of cleansing bin 300 into thirds.

In at least some embodiments, each of a plurality of dividers 304 may be the same height and/or differing heights. In at least one embodiment, divider 304 may comprise the same material as panels (102, 104, 106, 108). In at least one embodiment, a toothed divider 306 may be slid into divider grooves 302 to subdivide the interior volume of cleansing bin 300 and/or provide a post around which/on which to place objects to be cleaned.

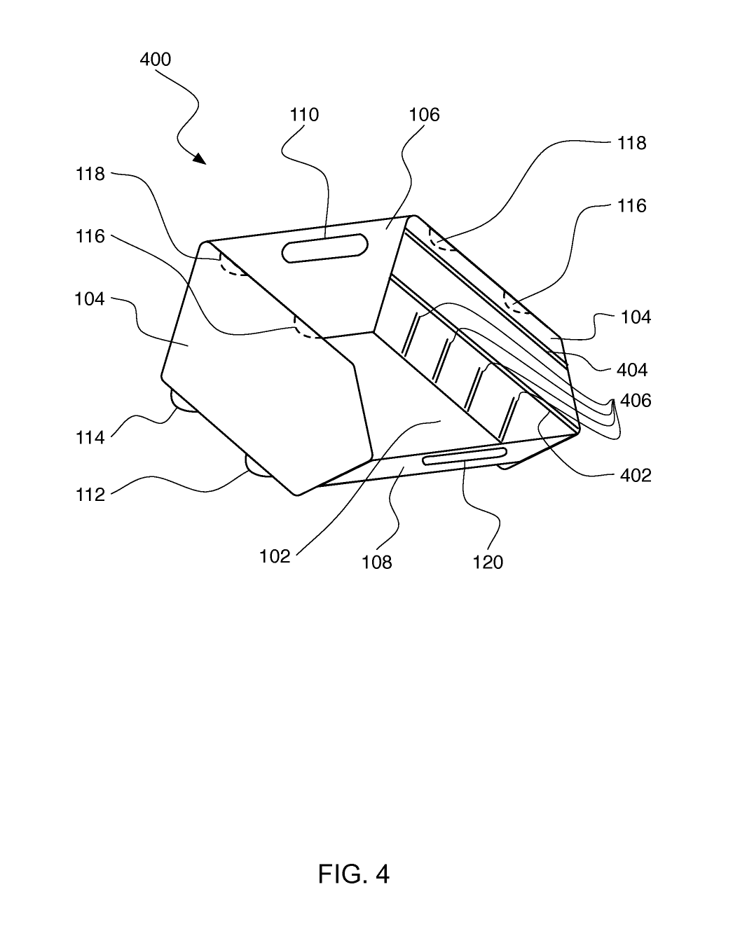

FIG. 4 depicts a perspective view of a cleansing bin 400 according to a fourth embodiment. Cleansing bin 400 differs from cleansing bin 100 in the addition of a first tray groove 402 extending horizontally and formed on each of side panels 104, a second tray groove 404 extending horizontally and formed on each of the side panels, and a set of divider grooves 406 extending vertically and formed on each of side panels 104. First and second tray grooves 402, 404 are similar to first and second tray grooves 202, 204 (FIG. 2) and the set of divider grooves 406 are similar to the set of divider grooves 302 (FIG. 3). First and second trays 206, 208 may be used in first and second tray grooves 402, 404 and one or more of dividers 304 and 306 may be used in the set of divider grooves 406.

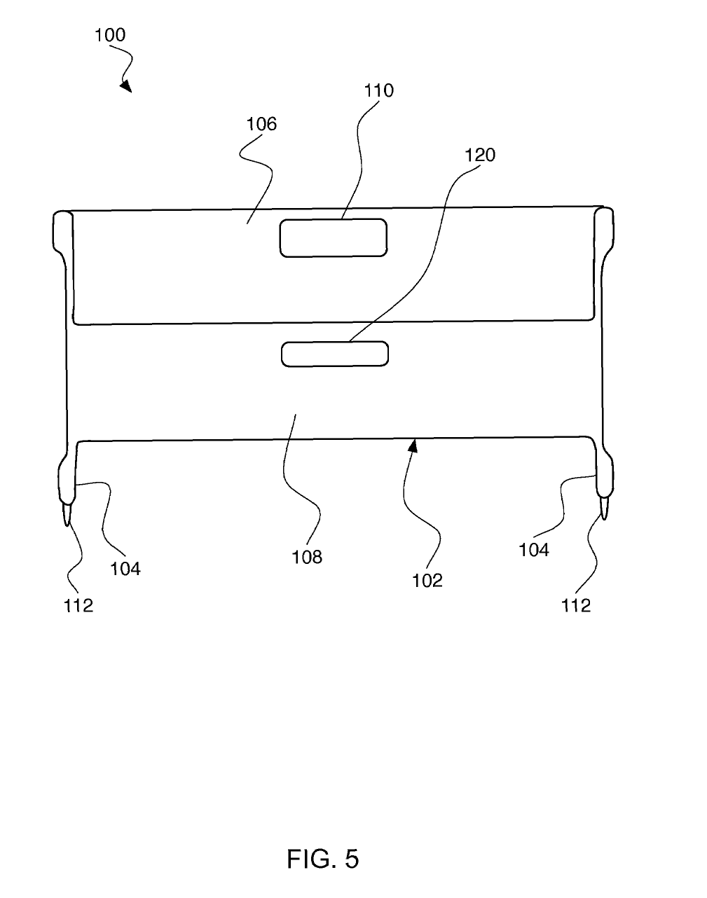

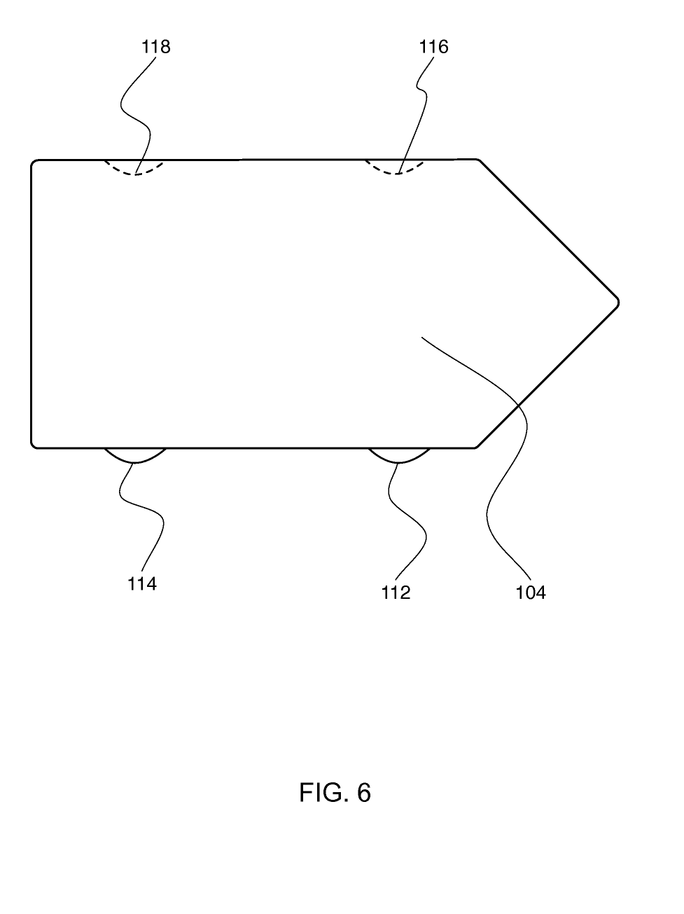

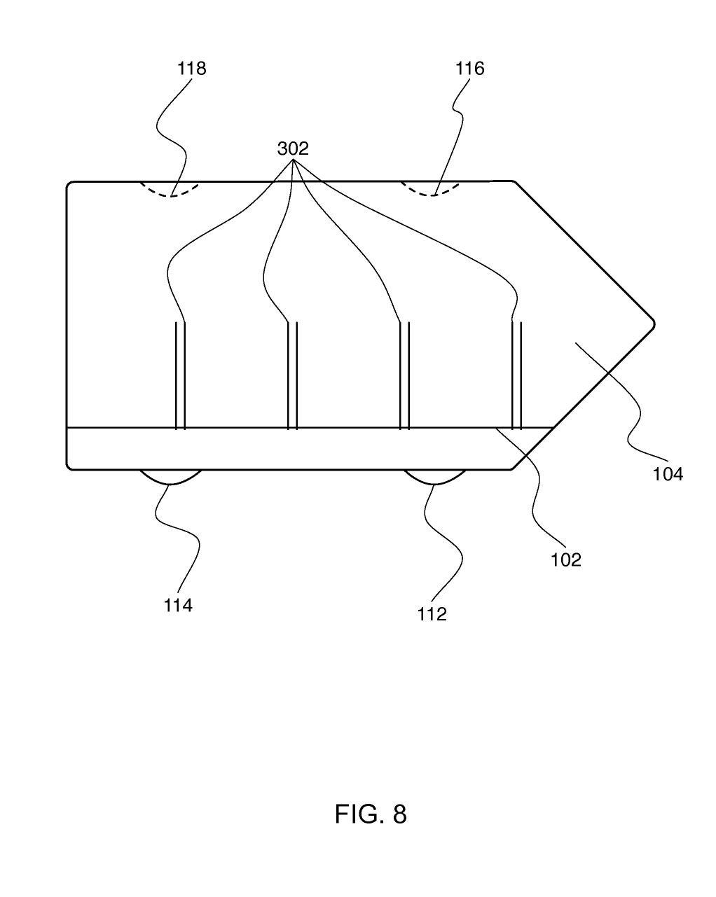

FIG. 5 depicts a front view of cleansing bin 100. FIG. 6 depicts a side view of cleansing bin 100. FIG. 7 depicts a side view of an inner face of one of side panels 104 according to the second embodiment described above. FIG. 8 depicts a side view of an inner face of one of side panels 104 according to the third embodiment described above.

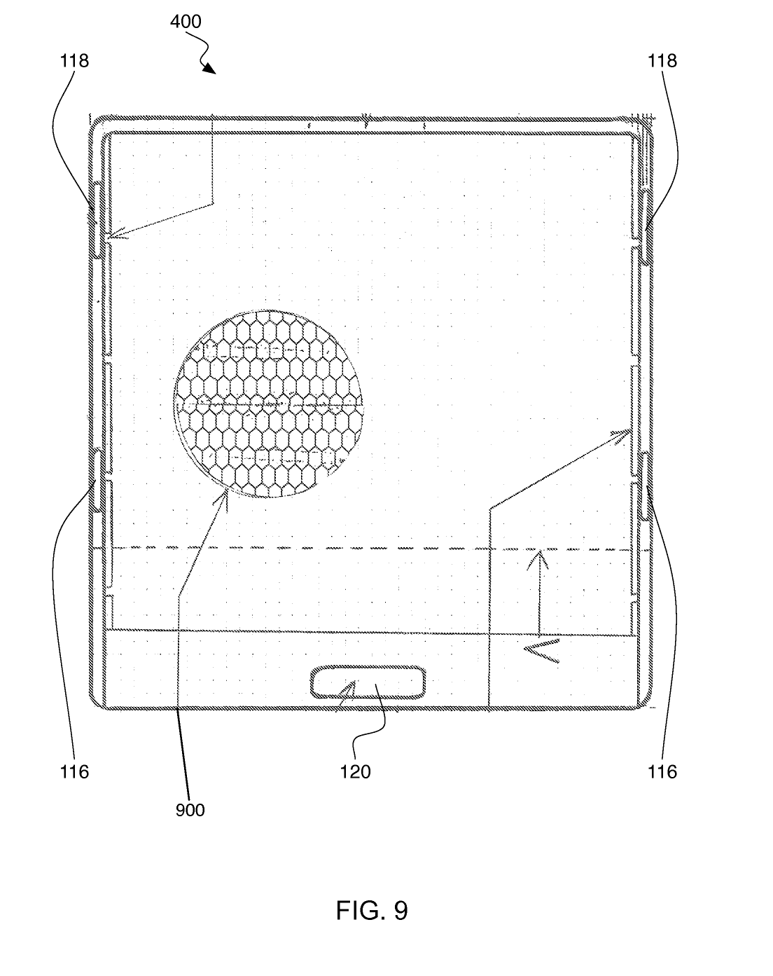

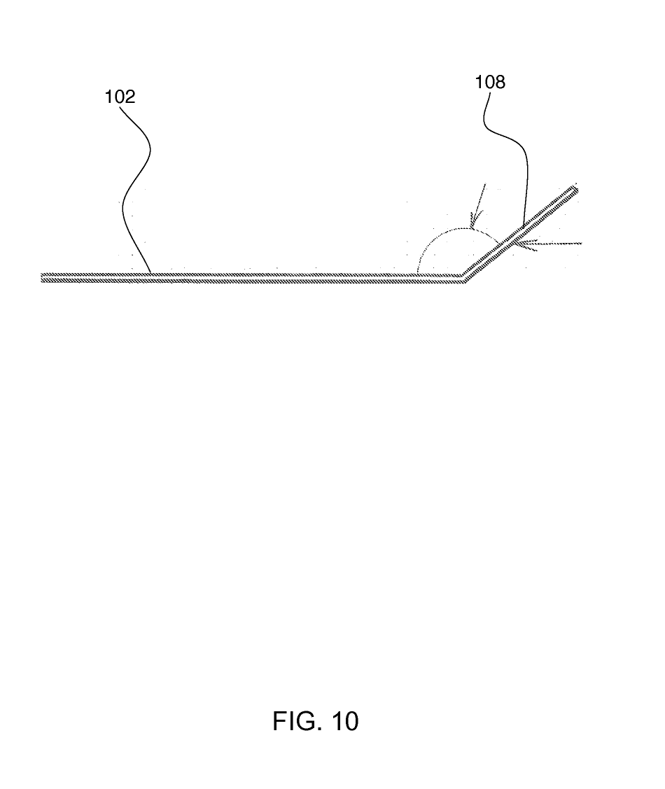

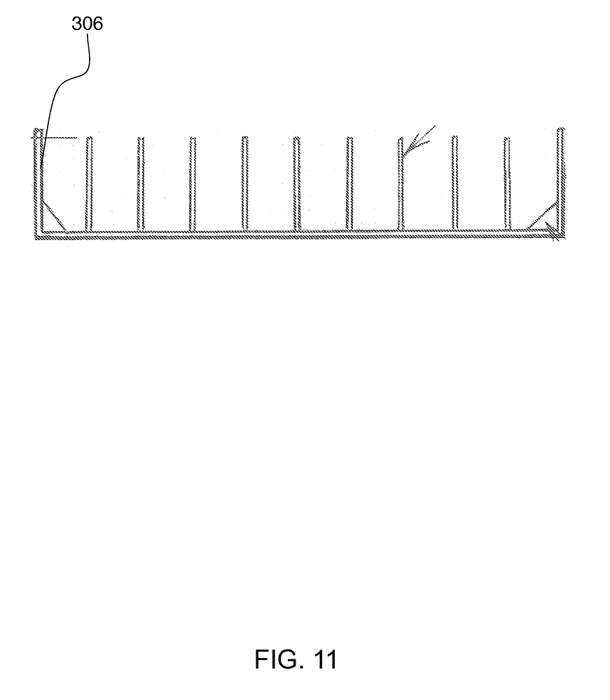

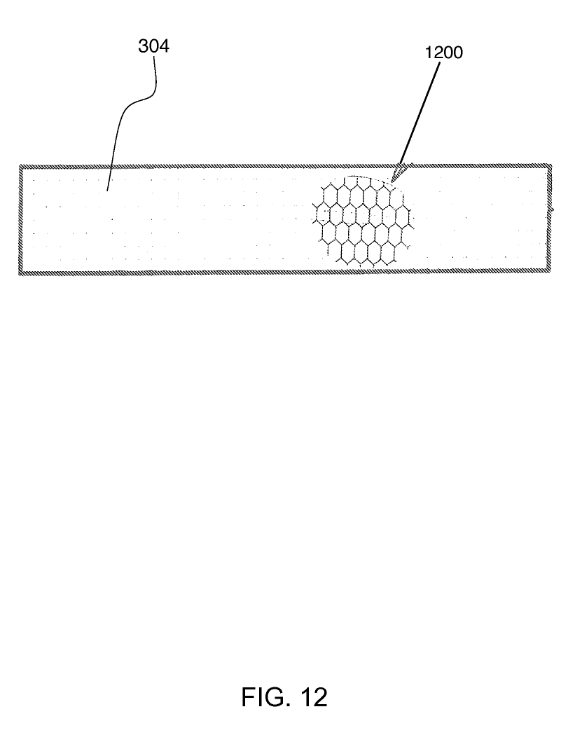

FIG. 9 depicts a top view of cleansing bin 400 according to the fourth embodiment. As depicted in FIG. 9, bottom panel 102 comprises a honeycomb-like material as indicated by enlarged portion 900. FIG. 10 depicts a side view of bottom panel 102 and front panel 108. FIG. 11 depicts a plan view of a toothed divider 306 usable in conjunction with an embodiment. FIG. 12 depicts a plan view of a divider 304 usable in conjunction with an embodiment. As depicted in FIG. 12, divider 304 comprises a honeycomb-like material as indicated by enlarged portion 1200. In at least some embodiments, divider 304 comprises a solid material. FIG. 10 depicts a side view of bottom panel 102 and front panel 108.

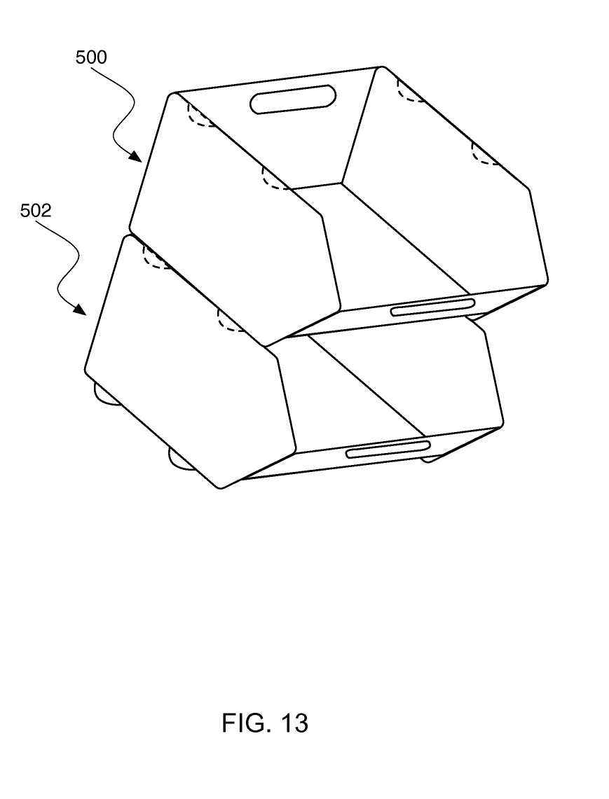

FIG. 13 depicts a perspective view of a first cleansing bin 500 positioned in stacked relation on top of a second cleansing bin 502. Feet 112, 114 of first cleansing bin 500 are received in receptacles 116, 118 of second cleansing bin 502.

In some embodiments, the panels (102, 104, 106, 108) may be joined together by welding, gluing, or other joining mechanism. In some other

What is claimed is:

1. A bin for use in a dishwasher machine, comprising:
a pair of opposing side panels, each side panel comprising at least one foot along a lower edge, each side panel defining at least one depression along an upper edge;
a rear panel connected to each of the pair of opposing side panels;
a front panel connected to each of the pair of opposing side panels; and
a bottom panel connected to (a) each of the pair of opposing side panels, (b) the rear panel, and (c) the front panel.

2. The bin as claimed in claim 1, wherein the side panel defined depression is arranged to receive a corresponding foot of an other bin in stacked relation to the bin.

3. The bin as claimed in claim 1, wherein the feet of the side panels comprise a convex portion of the side panel.

4. The bin as claimed in claim 1, wherein the front panel extends at an oblique angle away from the bottom panel.

5. The bin as claimed in claim 1, wherein each of the side panels comprises at least one groove extending along an inner face of the side panel from the rear panel toward the front panel for receiving a tray in parallel relation to the bottom panel.

6. The bin as claimed in claim 5, wherein each of the side panels comprises two parallel grooves extending along the inner face of the side panel from the rear panel toward the front panel for receiving a tray in parallel relation to the bottom panel.
embodiments, cleansing bin 100 may be formed as a single unit. In some embodiments, grooves formed for first and second tray grooves and the set of divider grooves may be formed from raised portions of side panels 104 and/or may be formed by scoring and/or etching a groove into the surface of side panels 104.
In at least one embodiment, cleansing bin 100 may be used to replace an upper rack and/or a lower rack of a dishwasher machine.
It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

7. The bin as claimed in claim 1, wherein each of the side panels comprises at least one groove extending along an inner face of the side panel from the bottom panel toward the upper edge for receiving a divider.

8. The bin as claimed in claim 7, wherein each of the side panels comprises two parallel grooves extending along the inner face of the side panel from the bottom panel toward the upper edge for receiving a divider.

9. The bin as claimed in claim 1, wherein the bin is sized to replace a rack of a dishwasher machine.

10. The bin as claimed in claim 1, wherein at least one of the pair of side panels, the bottom panel, the front panel, and the rear panel comprises a mesh material.

11. A pair of stackable bins for use in a dishwasher machine, comprising:
a first bin as claimed in claim 1; and
a second bin as claimed in claim 1, wherein the feet of the first bin are positioned to interfit into the depression of the second bin if the first bin is positioned above the second bin.

12. A method of cleansing one or more items, comprising:
placing one or more items into a bin, wherein the bin comprises:
a pair of opposing side panels, each side panel comprising at least one foot along a lower edge, each side panel defining at least one depression along an upper edge;
a rear panel connected to each of the pair of opposing side panels;
a front panel connected to each of the pair of opposing side panels; and
a bottom panel connected to (a) each of the pair of opposing side panels, (b) the rear panel, and (c) the front panel;
positioning the bin in an interior of a dishwasher machine; and
operating the dishwasher machine to wash the items in the bin.

13. The method as claimed in claim 12, wherein the positioning comprises:
replacing an existing dishwasher machine rack with the bin.

14. The method as claimed in claim 12, wherein the placing comprises:
placing one or more toy items into the bin.

15. The method as claimed in claim 12, wherein the positioning comprises:
removing the bin from a position atop an other bin.
